(19) United States
(12) Patent Application Publication
(10) Pub. No.: US 2007/0138882 A1
(43) Pub. Date: Jun. 21, 2007

(54) Motor module

(75) Inventors: Hiroyuki Tsukashima, Aichi-ken (JP); Takamasa Takeuchi, Aichi-ken (JP); Kazumoto Konda, Mie-ken (JP); Sho Miyazaki, Mie-ken (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Aichi-ken (JP)

(21) Appl. No.: 10/572,654

(22) PCT Filed: Feb. 10, 2005
(86) PCT No.: PCT/JP05/02536

§ 371 Date: Mar. 20, 2006

(30) Foreign Application Priority Data
Feb. 13, 2004 (JP) 2004-037104

(51) Int. Cl. B60K 1/00; H02K 11/00

(52) U.S. Cl. 310/71; 180/65.5

(57) ABSTRACT

A feed cable to a motor is electrically connected to an internal conductor of a terminal block by a contact, by a mating structure of a male connector and a female connector. To the tip of varnish-treated motor winding, a flexible bus bar that is a flexible member is connected. By electrically connecting the motor winding to the internal conductor via the flexible bus bar with high flexibility, the feed cable and the motor winding are electrically connected. The component tolerance can be absorbed by deformation of the flexible bus bar, and the motor module can be fastened to the terminal block unforcedly.

### TECHNICAL FIELD

The present invention relates to a motor module, and more specifically, to a motor module in which a motor winding is varnish-treated.

### BACKGROUND ART

In general, in order to ensure insulation of the surface of a conductive wire such as motor winding, “varnish treatment” is performed, in which a transparent surface coating referred to as varnish is applied. As such varnish, for example, a solution in which a resin-like material is dissolved in a solvent is employed.

Although such varnish treatment is necessary to ensure insulation, the lead wire hardens as the varnish solidifies. Accordingly, as a method for preventing hardening of a motor lead wire by varnish treatment, a technique for preventing varnish from permeating into a lead wire through capillary phenomenon is disclosed (for example, Japanese Patent Laying-Open No. 2002-78301).

During assembly of an on-board motor module, a mechanism for absorbing an error within a tolerance related to size, plumbness, mounting position and the like of each component of the motor module (hereinafter referred to as “component tolerance”) is required. In general, the component tolerance can be absorbed by connecting a longer motor winding to allow slack.

However, when the varnish treatment is provided to motor winding for ensuring insulation, the degree of freedom in wiring is still small even after the measure disclosed in Patent Document 1 has been taken, since the flexibility of the motor winding itself is small. Accordingly, when the motor module is mounted in a narrow space, as the distance between the stator of the motor module and a terminal block is small, the degree of freedom of the motor winding is small and it is difficult to absorb the component tolerance by the motor winding.

If the motor module is connected to the terminal block in a state where the component tolerance is not fully absorbed, a stress may be applied to the motor winding of which insulation has been ensured by the varnish treatment, and a failure such as loss of the ensured insulation may be caused. On the other hand, if each component tolerance is just strictly set in order to better assemble the motor module to the terminal block, the costs may be increased.

Additionally, since the degree of freedom in the motor winding itself is small, the work efficiency of assembly may be decreased.

### DISCLOSURE OF THE INVENTION

An object of the present invention is to absorb the component tolerance during assembly and to improve efficiency of the assembly, in a motor module where a motor winding has been subjected to varnish treatment.

A motor module according to the present invention is a motor module supplied with electric power from an external wiring, and it includes a motor winding having been subjected to varnish treatment, and a terminal block electrically connecting the motor winding to the external wiring. The terminal block includes a first contact electrically connecting an internal conductor and the external wiring, and a second contact electrically connecting the internal conductor and the motor winding. The motor winding is connected to the internal conductor via a flexible member that is conductive and that is higher than the motor winding in flexibility.

With the motor module according to the present invention, the varnish-treated motor winding is connected to the internal conductor of the terminal block via a flexible member. Accordingly, the deformation of the flexible member absorbs the component tolerance so that the motor module is fasted to the terminal block unforcedly, and therefore the work efficiency of assembly is improved.

Preferably, in the motor module of the present invention, the flexible member is formed by a braided wire.

In the motor module, permeation of varnish through capillary phenomenon can be suppressed by forming the flexible member using the braided wire in which strands have large intervals among them, and therefore the flexibility of the flexible member can be improved.

Alternatively, preferably, in the motor module of the present invention, the flexible member is formed by a plate-like conductor having an elastically deformable portion.

In the motor module, as the flexible member is formed using the plate-like conductor having an elastically deformable portion, the flexible member does not harden affected by the varnish treatment to the motor winding. Accordingly, the flexibility of the flexible member can be improved.

Further preferably, in the motor module of the present invention, the first contact has a structure where the internal conductor and the external wiring are allowed to mate with each other in a perpendicular direction to a rotation shaft of a motor, and the motor winding is attached to the second contact in the rotation shaft direction of the motor.

In the motor module, by employing a fixing structure where the rotor is inserted along the motor rotation shaft direction, the motor module can be assembled to the terminal block absorbing each component tolerance, even when the arrangement limitation in the direction (vertical direction) perpendicular to the motor rotation shaft direction is demanding.

Particularly in such a structure, the second contact has a plate-like terminal attached to a tip of the flexible member, and a fixing member fastening the terminal and the internal conductor to each other and thereby electrically connecting them. The terminal is fastened to the internal conductor by the fixing member in a state where the flexible member is deformed such that the terminal is positioned along the perpendicular direction.

In the motor module, by fastening internal conductor and terminal while terminal is positioned along the direction perpendicular to the motor rotation shaft direction, the motor module can be assembled to the terminal block absorbing each component tolerance, without increasing the size in the direction along the motor rotation shaft direction.

### BRIEF DESCRIPTION OF THE DRAWINGS

FIG. 1 is a schematic block diagram showing a configuration of a hybrid vehicle shown as an example incorporating a motor module according to the present invention.

FIG. 2 is a conceptual diagram showing an arrangement area of a rear motor shown in FIG. 1.

FIG. 3 is an appearance diagram showing a housing storing the motor module according to the present invention.

FIG. 4 shows a cross section of the motor module according to the present invention.

FIG. 5 describes in detail a configuration of a connecting member shown in FIG. 4.

FIG. 6 shows another configuration example of a flexible member shown in FIG. 5.

FIG. 7 is a schematic block diagram showing a configuration of an FR (Front-engine Rear-Drive) type hybrid vehicle shown as another example incorporating the motor module according to the present invention.

FIG. 8 is a cross sectional view along VIII-VIII in FIG. 7.

### BEST MODES FOR CARRYING OUT THE INVENTION

Referring to the drawings, an embodiment of the present invention will be described in detail. An identical reference character is allotted to identical or corresponding parts in the drawings, and description thereof is not repeated.

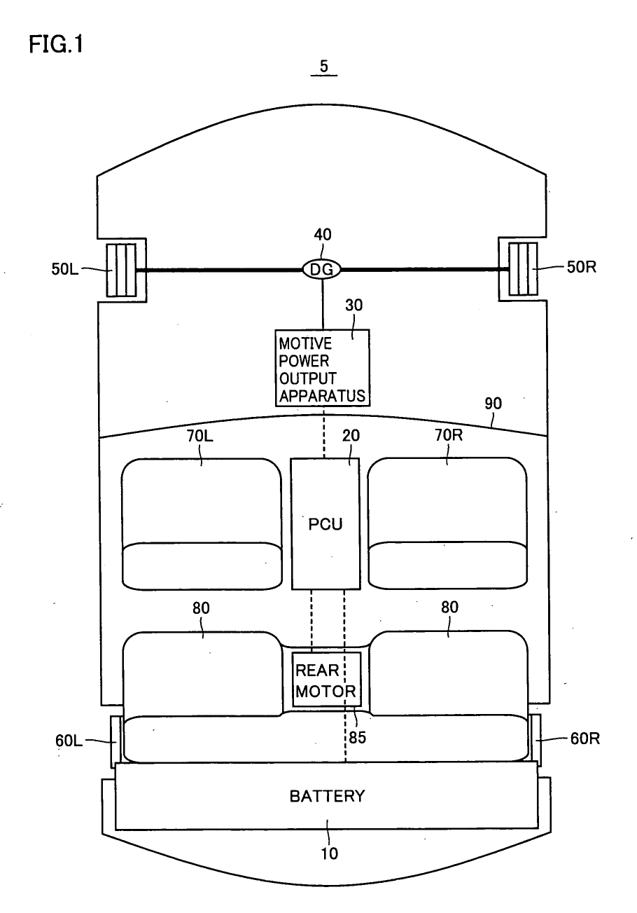

FIG. 1 is a schematic block diagram showing a configuration of a hybrid vehicle shown as an example incorporating a motor module according to the present invention.

Referring to FIG. 1, a hybrid vehicle 5 according to the embodiment of the present invention includes a battery 10, a PCU (Power Control Unit) 20, a motive power output apparatus 30, a DG (Differential Gear) 40, front wheels 50L and 50R, rear wheels 60L and 60R, front seats 70L and 70R, a rear seat 80, and a rear motor 85.

Battery 10 is formed, for example, by a secondary battery such as a nickel-hydride metal battery or a lithium ion battery, and it supplies a direct voltage to PCU 20 and charged by a direct voltage from PCU 20. Battery 10 is arranged behind rear seat 80.

Motive power output apparatus 30 is arranged in an engine room in front of a dashboard 90, and includes an engine and a motor for driving front wheels 50L and 50R. DG 40 transmits motive power from motive power output apparatus 30 to front wheels 50L and 50R, and transmits rotational force of front wheels 50L and 50R to motive power output apparatus 30.

Thus, motive power output apparatus 30 transmits motive power from the engine and/or motor generator to front wheels 50L and 50R via DG 40, and thereby drives front wheels 50L and 50R. Additionally, motive power output apparatus 30 generates electric power by the rotational force of front wheels 50L and 50R, and supplies the generated electric power to PCU 20.

Rear motor 85 is provided for driving rear wheels 60L and 60R, and fastened to axles for rear-wheel drive via a not-shown clutch, as needed. Fastening the clutch, what is called four-wheel-drive (4WD) running can be realized during running on an adverse-conditioned road (the road with low frictional coefficient) or during abrupt acceleration.

PCU 20 boosts a direct voltage from battery 10, and converts the boosted direct voltage to an alternating voltage to generate driving electric power of a front-wheel-drive motor and rear motor 85 in motive power output apparatus 30. Additionally, during regenerative braking operation of the front-wheel-drive motor and rear motor 85, PCU 20 converts the generated alternating voltage to a direct voltage to charge battery 10.

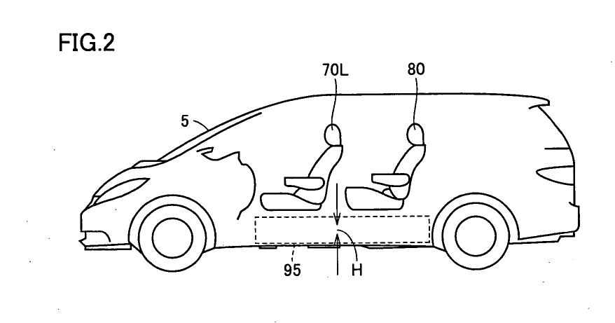

As shown in FIG. 2, PCU 20 and rear motor 85 are provided at area 95 under the floor. Since rear motor 85 is arranged at such a limited area, its mounting space is largely limited in the arrangement in upper-lower direction H. Additionally, since it shares area 95 with PCU 20, the occupying area is required to be small also in the plane direction.

To rear motor 85, of which limitation in arrangement is demanding and the mounting space is small as described above, a motor module according to the present invention, which will be described below in detail, can be applied.

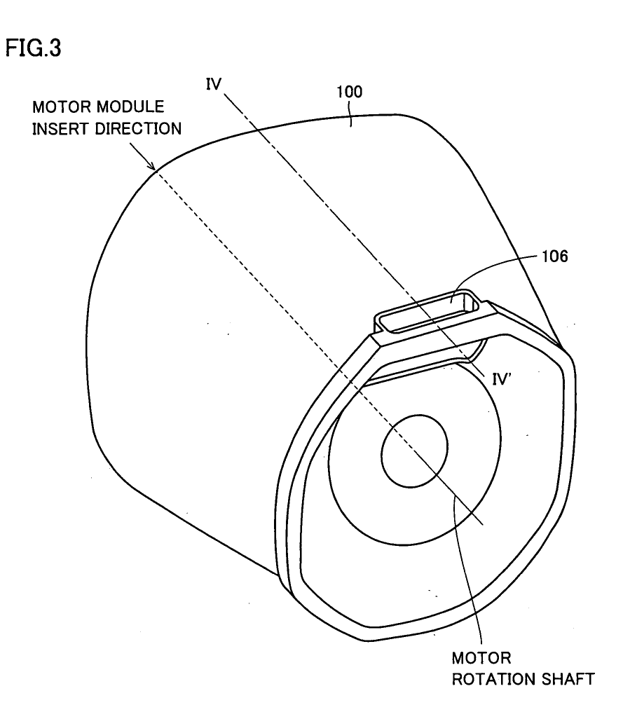

Referring to FIG. 3, a housing 100 accommodating the motor module (not shown) according to the embodiment includes a connector slot 106. The motor module is inserted in a direction along a motor rotation shaft with respect to housing 100 and thereby assembled.

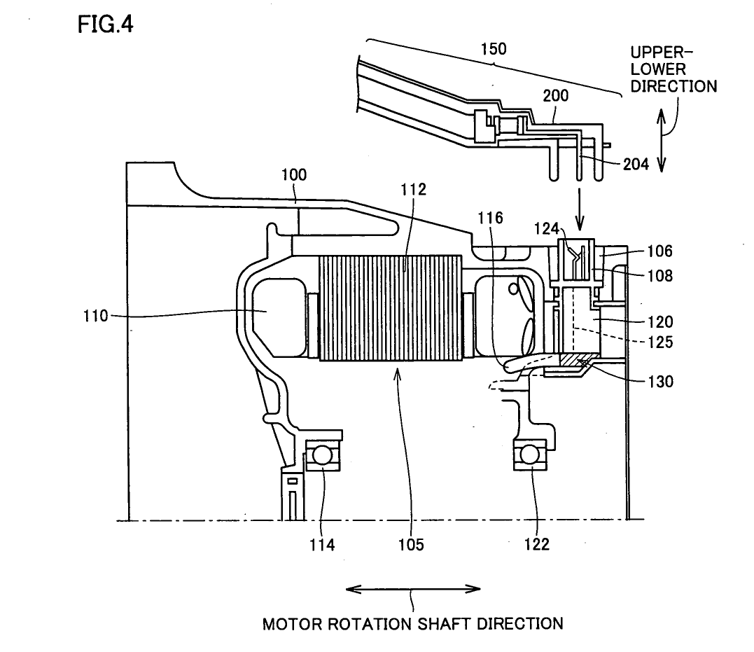

FIG. 4 shows a cross section of the motor module showing a cross section along IV-IV′ in FIG. 3.

As shown in FIG. 4, housing 100 of the motor module according to the present embodiment accommodates a stator 105 of a rotating electric machine, bearings 114 and 122, and a terminal block 120. Stator 105 is configured by a coil 110 and a stator core 112.

To connector slot 106 of housing 100, a feed cable 150 that corresponds to an “external wiring” is attached. To an end of feed cable 150, a male connector 200 including a contact 204 is provided.

Male connector 200 is formed in a shape that conforms to housing 100 when mating. Accordingly, when male connector 200 mates with connector slot 106 side, the cable is prevented from protruding in the radial direction of the motor module or the connector is prevented from protruding from the housing. Accordingly, the mounting space of the motor module can be saved even in a narrow space. Male connector 200 attains the similar effect when formed in an L-shape also.

Terminal block 120 is provided integrally with the housing. Terminal block 120 includes a female connector 108, an internal conductor 125, a contact 124 corresponding to “a first contact” for electrically connecting feed cable 150 and internal conductor 125, and a connecting member 130 corresponding to “a second contact” for electrically connecting internal conductor 125 and motor winding 116. Inside terminal block 120, contact 124 and connecting member 130 are electrically connected via internal conductor 125.

Female connector 108 is provided corresponding to connector slot 106 so as to mate with male connector 200. Although the connector shape of male connector 200 and that of female connector 180 are not specifically limited, in the present embodiment, the male connector has a convex shape, while the female connector has a concave shape, for example.

Female connector 108 is provided with a contact 124. Contact 124 is provided so that it is brought into contact with contact 204 when female connector 108 and male connector 200 mate with each other.

Stator core 112 has a hollow cylindrical shape. Stator core 112 has a plurality of slots. Coil 110 is wrapped and fixed to the slots. Then, the stator core 112 is fastened by a bolt, for example, to housing 100 and fixed. The shaft (not shown) of the rotor of the motor module is rotatably supported by bearings 114 and 122.

Motor winding 116 of the stator is electrically connected to internal conductor 125 of the terminal block by connecting member 130. Although different reference characters are allotted to coil 110 and motor winding 116, they are electrically the same member. In other words, motor winding 116 corresponds to a lead wire for externally connecting coil 110. Accordingly, by electrically connecting motor winding 116 and feed cable 150 via terminal block 120, coil 110 of the stator is electrically supplied.

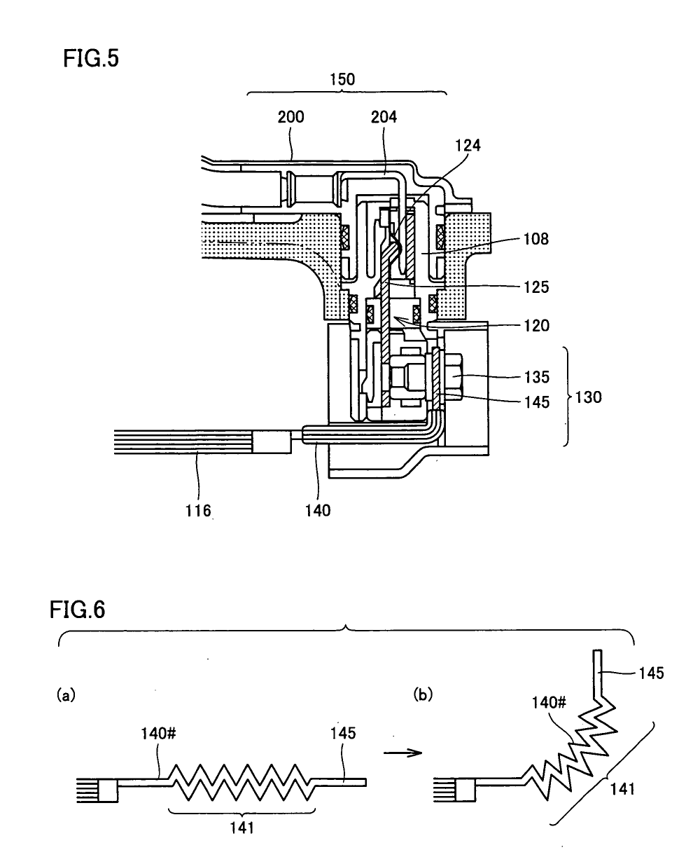

Next, referring to FIG. 5, a configuration of connecting member 130 according to the embodiment of the present invention will be described in detail.

Referring to FIG. 5, to the tip of varnish-treated motor winding 116, a flexible bus bar 140 that corresponds to “a flexible member” higher than motor winding 116 in flexibility is connected by caulking. Flexible bus bar 140 may be formed by a braided copper wire, stacked thin copper plates, a stranded wire or bundled fine copper wires.

In particular, by using the braided wire in which strands have large intervals among them, permeation of varnish through capillary phenomenon can be suppressed, and therefore the flexibility of flexible bus bar 140 can be improved.

To the tip of flexible bus bar 140, a plate-like terminal 145 is connected. Terminal 145 is electrically connected to internal conductor 125 by a fixing member 135 of a conductor. Fixing member 135 is representatively configured by a set of metal bolt and nut. Correspondingly, a bolt hole is provided at terminal 135.

Next, an assembly process of the motor module to housing 100 is described.

First, stator 105 is inserted and fixed to housing 100 along a motor rotation shaft direction.

Next, terminal block 120 is inserted from above to housing 100. In this state, flexible bus bar 140 of motor winding 116 is further inserted from the lateral direction (motor rotation shaft direction), and the position of terminal 145 is adjusted so as to absorb the component tolerance between stator 105 and terminal block 120. By fastening fixing member 135 after such adjustment of the position, terminal block 120 is fixed integrally with housing 100.

After alignment is completed and terminal block 120 is fixed to housing 100, feed cable 150 is attached to connector slot 106, and feed cable 150 and coil 110 of the stator are electrically connected. Thus, the motor module can electrically be fed.

As described above, by electrically connecting motor winding 116 to internal conductor 125 via flexible bus bar 140 with high flexibility, connecting member 130 can have a component tolerance absorbing mechanism. Such absorption of the component tolerance allows the motor module and the terminal block to be fastened to each other unforcedly, and therefore assemble workability is improved.

In particular, by employing a fixing structure where the rotor is inserted along the motor rotation shaft direction, the motor module can be assembled to the terminal block absorbing each component tolerance, even when the arrangement limitation in the direction (upper-lower direction in the present embodiment) perpendicular to the motor rotation shaft direction is demanding.

Further, as internal conductor 125 and terminal 145 are fastened while terminal 145 is positioned along the vertical direction, the motor module can be assembled to the terminal block absorbing each component tolerance, without increasing the size in the direction along the motor rotation shaft direction.

Additionally, as the structure allows the insertion and alignment of terminal 145 as well as the fastening work of fixing member 135 to be performed from the same direction (the direction indicated by an arrow in FIG. 5), the assembly step of the motor module can be simplified.

Alternatively, the effect similar to that described above can be attained by forming the “flexible member” by a plate-like conductor 140# having a spring-like portion 141 as shown in FIGS. 6(a) and (b) to be used in place of flexible bus bar 14 shown in FIG. 5.

As shown in FIG. 6(b), plate-like conductor 140# attains the similar function as flexible bus bar 140 shown in FIG. 5 by elastic deformation of spring-like portion 141. Specifically, by the elastic deformation of spring-like portion 141, the component tolerance during motor module assembly can be absorbed.

It is noted that the flexibility of the flexible member can be improved since plate-like conductor 140# does not harden as affected by the varnish treatment of motor winding 116.

As above, although the example where the present invention is applied to a rear-wheel-drive motor of hybrid vehicle 5 shown in FIG. 1 as a representative example of the motor module having a limited mounting space, the application of the present invention is not limited to such a manner.

As one example, the motor module according to the present invention can be incorporated in a hybrid vehicle of FR (Front-engine Rear-Drive) type of which arrangement limitation of the motor is demanding.

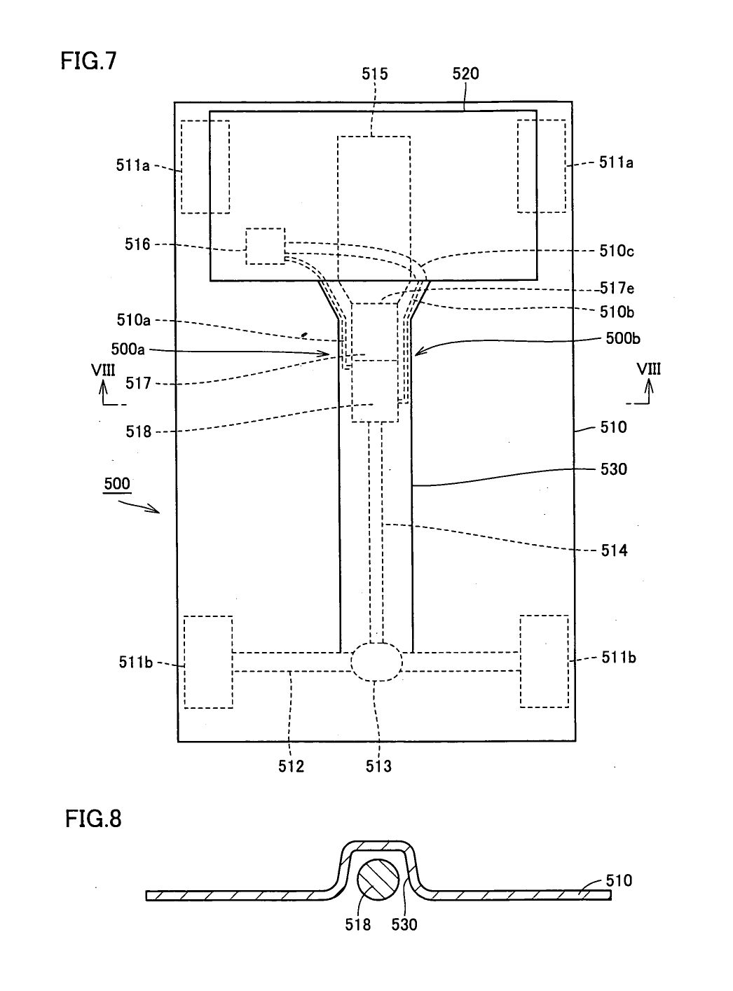

FIG. 7 is a schematic block diagram showing a configuration of a hybrid vehicle of FR type shown as another example incorporating the motor module according to the present invention.

Referring to FIG. 7, hybrid vehicle 500 of FR type includes a chassis 510 having an engine compartment 520 where an engine 515 is arranged and a tunnel 530 continuing to engine compartment 520, a propeller shaft 514 and electric motors 517 and 518 as a drive unit, and vehicle connectors 500a and 500b connected to electric motors 517 and 518.

Vehicle connectors 500a and 500b include bus bars 510a and 510b that extend at least from electric motors 517 and 518 to engine compartment 520 inside tunnel 530. Hybrid vehicle 500 further includes an inverter 516 provided in engine compartment 520. Bus bar 510a extends to inverter 516. Hybrid vehicle 500 further includes a flexible wire 510c that connects inverter 516 and bus bar 510b.

Vehicle connector extends to a front end 517e of electric motor 517 as a front end of the drive unit.

At the four corners of chassis 510, front wheels 511a and rear wheels 511b are attached.

Engine compartment 520 is a space positioned between front wheels 511a for accommodating engine 515. Inside engine compartment 520, not only engine 510 but also inverter 516 for supplying electric power to electric motors 517 and 518 are provided. In FIG. 7, engine 515 is arranged so that its length extends toward the traveling direction, that is, it is what is called an “length side type” engine. It is noted that the type of engine 515 is not specifically limited, and various commonly used types such as in-line engine, V engine, horizontally-opposed engine can be employed. Further, not only a gasoline engine but also a diesel engine can serve as engine 515. Additionally, an engine using other gases as its fuel may be employed.

Although inverter 516 is provided on the left side of engine 515, it is not limited thereto and it may be provided on the right side of engine 515 or coaxially to engine 515.

Tunnel 530 is provided continuously to engine compartment 520. Tunnel 530 is a space for accommodating electric motors 517 and 518 and propeller shaft 514.

Electric motors 517 and 518 are each motor/generator, and serve to alternately convert driving force and electric power. Although two electric motors 517 and 518 are provided in FIG. 7, only one electric motor may be provided. Additionally, three or more electric motors may be provided.

A transmission (a planetary for a splitter or the like) may be accommodated in tunnel 530. The transmission is arranged between electric motor 518 (M/G) and propeller shaft 514.

To electric motors 517 and 518, vehicle connectors 500a and 500b are connected. Vehicle connector 500a is connected to electric motor 517. Vehicle connector 500b is connected to electric motor 518. Vehicle connector 500a has bus bar 510a. Bus bar 510a extends from electric motor 517 to inverter 516, and connects inverter 516 and electric motor 518. Bus bar 510a is formed by a plate-like metal member, and a part thereof extends inside tunnel 530, while the rest extends inside engine compartment 520.

To electric motor 518, bus bar 510b of vehicle connector 500b is connected. Bus bar 510b extends inside tunnel 530 from electric motor 518 to engine compartment 520. Inside engine compartment 520, bus bar 510b is connected to wire 510c formed by a copper wire. Wire 510c connects inverter 516 and bus bar 510b.

The output from electric motor 518 is transmitted to rear wheels 511b via propeller shaft 514, differential gear 513 and axle 512. Although engine 515 is provided on the front side of the vehicle, the position of the engine is not limited to this portion, and it may be provided at the central portion of the vehicle.

FIG. 8 is a cross sectional view along line VIII-VIII in FIG. 7. Referring to FIG. 8, the protruding portion of chassis 110 is tunnel 530. Tunnel 530 is formed in a protruding shape and thereby serves to improve strength of chassis 510. Electric motor 518 is provided inside tunnel 530. Although not shown, inside tunnel 530, a connector for supplying electric power to electric motor 518 is attached. This vehicle connector is arranged between electric motors 518 and 517 and the side wall of tunnel 530.

As above, electric motor 518 in a FR-type hybrid vehicle is provided inside tunnel 530, and the mounting space thereof is largely limited. Accordingly, the structure of the motor module according to first to third embodiments is also suitable for application to electric motor 518.

The motor module according to the present invention can be applied commonly to other motors incorporated in hybrid vehicles and to motors incorporated in other automobiles, vehicles, appliances and the like, which are configured to be fixed to a terminal block integrally provided to the motor housing and thereby electrically connected externally.

It should be understood that the embodiments disclosed herein are illustrative and non-restrictive in every respect. The scope of the present invention is defined by the terms of the claims, rather than the description and example above, and is intended to include any modifications and changes within the scope and meaning equivalent to the terms of the claims.

### INDUSTRIAL APPLICABILITY

The motor module according to the present invention is applicable to a motor that is incorporated in a hybrid vehicle, an automobile, a vehicle, an appliance and the like, and that is configured to be accommodated in a motor housing.

1. A motor module supplied with electric power from an external wiring, comprising:
a motor winding having been subjected to varnish treatment; and
a terminal block electrically connecting said motor winding to said external wiring,
said terminal block including
a first contact electrically connecting an internal conductor and said external wiring, and
a second contact electrically connecting said internal conductor and said motor winding; wherein
said motor winding is connected to said internal conductor via a flexible member that is conductive and that is higher than said motor winding in flexibility.

2. The motor module according to claim 1, wherein said flexible member is formed by a braided wire.

3. The motor module according to claim 1, wherein
said flexible member is formed by a plate-like conductor having an elastically deformable portion.

4. The motor module according to claim 1, wherein
said first contact has a structure where said internal conductor and said external wiring are allowed to mate with each other in a perpendicular direction to a rotation shaft of a motor, and
said motor winding is attached to said second contact in the rotation shaft direction of said motor.

5. The motor module according to claim 4, wherein
said second contact has
a plate-like terminal attached to a tip of said flexible member, and
a fixing member fastening said terminal and said internal conductor to each other and thereby electrically connecting them, and wherein
said terminal is fastened to said internal conductor by said fixing member in a state where said flexible member is deformed such that said terminal is positioned along said perpendicular direction.

6. The motor module according to claim 2, wherein
said first contact has a structure where said internal conductor and said external wiring are allowed to mate with each other in a perpendicular direction to a rotation shaft of a motor, and
said motor winding is attached to said second contact in the rotation shaft direction of said motor.

7. The motor module according to claim 3, wherein
said first contact has a structure where said internal conductor and said external wiring are allowed to mate with each other in a perpendicular direction to a rotation shaft of a motor, and
said motor winding is attached to said second contact in the rotation shaft direction of said motor.
